(19) United States
(12) Patent Application Publication
(10) Pub. No.: US 2005/0121562 A1
(43) Pub. Date: Jun. 9, 2005

(54) Portable wrist rest system

(76) Inventor: Danny D. Baumgardner, Marshall, NC (US)

Correspondence Address: Theresa M. Seal;C/O The Inventor's Network, Inc., 332 Academy Street, Camegie, PA, 15106, US

(21) Appl. No.: 10/726,932

(22) Filed: Dec. 4, 2003

(51) Int. Cl. B43L 15/00

(52) U.S. Cl. 248/118.1; 248/918

(57) ABSTRACT

A portable wrist resting pad for relieving and alleviating the strain and fatigue to the wrist and arm from repetitive and continual use of a computer mouse and keyboard includes a first support member for disposition on the desk surface, a second support member mounted to the first support member and having a density less than the first support member, and a wrist strap that extends outwardly from opposite ends of the support members for encompassing the wrist and attaching the support pad to the wrist. The wrist support pad elevates the wrist the appropriate distance from the work surface to relieve strain and fatigue to the wrist and arm for preventing carpal tunnel syndrome; and preferably one wrist support pad should be secured to each wrist to obtain maximum benefit from the portable wrist rest pads.

### FIELD OF THE INVENTION

The present invention pertains to ergonomic support devices, and more particularly pertains to a portable support pad for the wrist and arm for alleviating and preventing repetitive motion injuries.

### BACKGROUND OF THE INVENTION

Computers have become ubiquitous in contemporary society as they are used in everything from ordering and processing meals at fast food restaurants and reserving campsites at campgrounds to booking and routing airliners and monitoring nuclear power plants. However, despite the central role of computers in modem society, their constant use has resulted in one fundamental physical and physiological problem that has yet to be overcome: the continual use of keyboard and mouse causes repetitive motion stress injuries, foremost among them being carpal tunnel syndrome. Carpal tunnel syndrome occurs when pressure is exerted on the median nerve at the point at which the median nerve passes through the carpal tunnel of the wrist. The result is soreness, weakness and tenderness of the wrist and hand. In addition, the hours spent working at a computer, and manipulating a mouse and keyboard, especially in office, engineering and drafting occupations, will also cause strain and overloading of the muscles of the neck and shoulders. Physicians, physical therapists, and design engineers have labored to both rehabilitate muscles and limbs injured from working in a computer dominated workplace, and also to design ergonomic assist and support devices to mitigate, alleviate or prevent such injuries from occurring.

Thus, the prior art discloses a number of devices for supporting the arm and wrist for relieving the load placed thereon and for alleviating and preventing their fatigue and injury.

For example, Stenvall (U.S. Pat. No. 4,822,103) discloses an armrest support upon which the forearm is placed, and guide rails and attachment members for securing the armrest support to a chair with the guide rails being horizontally and vertically adjustable.

The Moss et al. patent (U.S. Pat. No. 5,058,840) discloses an armrest assembly that includes a platen securable to a mounting surface, a slide pivotally mounted to the platen, a cradle mounted to the slide for receiving and supporting therein the forearm, and a bracket with a roller for allowing movement of the slide.

The Maxwell patent (U.S. Pat. No. 6,024,715) discloses a wrist brace that includes an elastic sleeve and an adjustable thumb engagement strap for receiving and supporting therein the hand and wrist of the user.

The Lehoux patent (U.S. Pat. No. 6,189,158 B1) discloses a rest support for a guitar that includes a flexible cushioned enclosure securable to the upper thigh of the individual and forming a pillow for supporting the strumming portion of the guitar.

The Bergsten et al. patent (U.S. Pat. No. 6,203,109 B1) discloses an ergonomic arm support that includes an armrest slidably mounted on a shroud, and the shroud is mounted to a cantilever disk that allows the shroud to move in at least four axes of motion. The cantilever disk also frictionally engages the shroud to lock the shroud in a position.

The Christensen patent (U.S. Pat. No. 6,311,939 B1) discloses a support for a mouse pad, wrist and arm, and includes an elongated support arm adjustably securable to attaching members with the support arm having an enlarged distal end for supporting a mouse pad thereon.

Nonetheless, despite the ingenuity of the above devices, there remains a need for a wrist support that is lightweight, portable and easy to attach and detach for alleviating muscle strain and fatigue and preventing repetitive motion injuries such as carpal tunnel syndrome.

### SUMMARY OF THE INVENTION

The present invention comprehends a portable resting pad or wrist support system for supporting and elevating the wrist of an individual involved in continuous computer operations for relieving, alleviating and preventing the strain and fatigue to the wrist, hand and arm resulting from repetitive and continual use of the computer keyboard and computer mouse.

The portable wrist-resting pad of the present invention comprises a comfortable padded platform that elevates the wrist, and the platform includes a dense first support member that is placed on the desk surface, and a softer second support member attached to the first support member and upon which the wrist of the individual rests. A wrist strap is placed between the first and second support members and extends outwardly therefrom on both opposite sides of the support members in order to encompass the wrist of the individual for securing the resting pad to the wrist. The first and second support members can be covered with a soft material covering for aesthetic and hygiene purposes. In order to properly and effectively use the system, it is preferred that each wrist be supported by one portable resting pad.

It is an objective of the present invention to provide a portable resting pad for supporting and elevating the wrist while typing, writing, or operating a computer mouse or a computer keyboard.

It is another objective of the present invention to provide a portable resting pad for alleviating and reducing the pressure on the carpal tunnel of the wrist for diminishing the prospects of being afflicted with carpal tunnel syndrome.

It is still another objective of the present invention to provide a portable resting pad for reducing desk clutter by having the wrist support device directly attached to the wrist of the individual.

It is still yet another objective of the present invention to provide a portable resting pad that enhances the operational freedom of the individual by allowing the individual to move among mouse, keyboard, and other devices while utilizing the same attached resting pad.

Still another objective of the present invention is to provide a portable resting pad that is portable, lightweight and easy to attach to the wrist and to detach therefrom.

Still yet another objective of the present invention is to provide a portable resting pad that elevates the individual's wrist the appropriate distance from the desk surface in order to relieve and alleviate wrist and arm fatigue and strain.

These and other objects, features, and advantages will become apparent to one skilled in the art upon a perusal of the following detailed description when read in conjunction with the following drawings and appended claims.

### BRIEF DESCRIPTION OF THE DRAWINGS

FIG. 1 is a perspective view of the portable resting pad of the present invention;

FIG. 2 is a sectioned elevational view of the portable resting pad of the present invention taken along lines 2-2 of FIG. 1;

FIG. 3 is a side elevational view of the portable resting pad first shown in FIG. 1 illustrating the elevation of the wrist by the portable resting pad; and

FIG. 4 is a top plan view of the portable resting pad first shown in FIG. 1 illustrating the attachment of the portable resting pad to the wrist of the individual.

### DETAILED DESCRIPTION OF THE PREFERRED EMBODIMENT

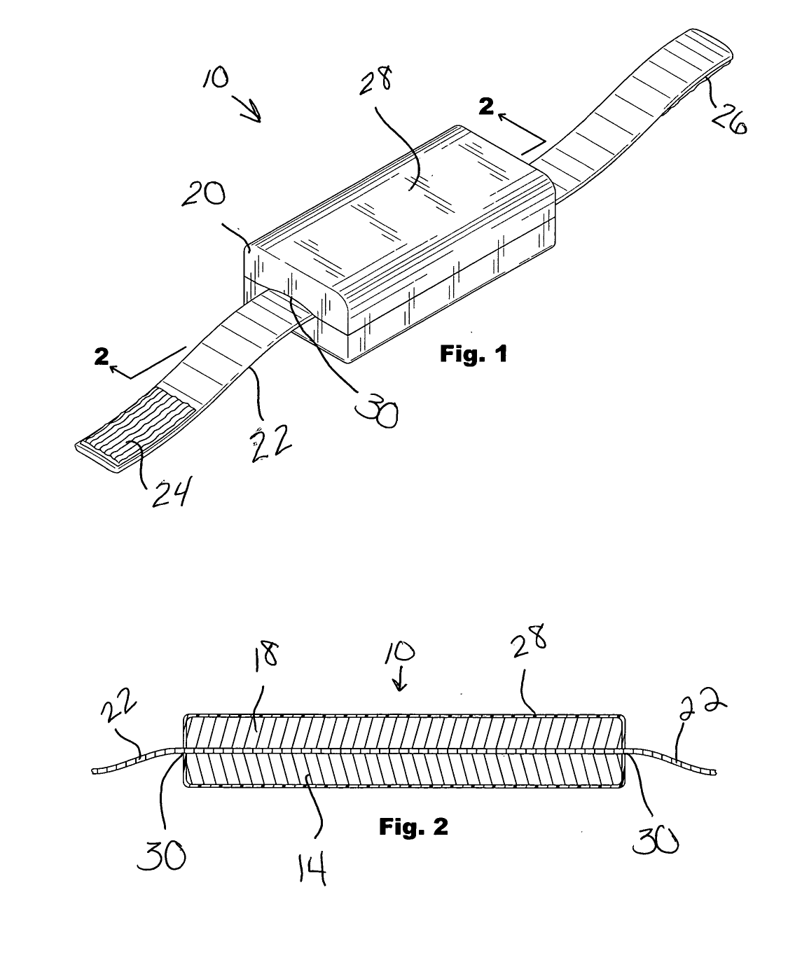

Illustrated in FIGS. 1-4 is a portable wrist rest system, or, more specifically, a portable wrist resting pad 10 for reducing and relieving the strain and fatigue primarily to the wrist and arm, but also secondarily to the shoulders and neck, from repetitive and continuous use of a computer mouse 11 or keyboard in order to prevent carpal tunnel syndrome.

The present invention is lightweight and portable and adapted for easy and quick attachment to, and detachment from, the user's wrist 12; and for maximum effectiveness each wrist 12 should have a portable resting pad 10 attached thereto. As shown in FIG. 1-4, the portable wrist-resting pad 10 includes a first support member 14 for disposition on the work surface 16 such as a desk or tabletop. The first support member 14 is a dense foam rubber block having a generally rectangular shape. A second support member 18 is superposed on the first support member 14 for forming the resting pad 10. The second support member 18 should have a density that is less than the density of the first support member 14, and the second support member 18 should preferably be a soft foam block composed of, for example, new memory foam. The upper periphery 20 of the second support member 18 is chamfered to snugly accommodate a structural member hereinafter further described.

As shown in FIGS. 1-4, an elongated, flexible wrist strap 22 is interposed between the upper surface of the first support member 14 and the lower surface of the second support member 18 and extends outwardly from the opposite short sides of both members 14 and 18. The wrist strap 22 is composed of the well known material Velcro R, and is further divided into two generally equal halves or portions with one half of the wrist strap 22 having the Velcro R hooks 24 facing up and the other half of the wrist strap 22 having the Velcro R latches 26 facing downward. In assembling the portable resting pad 10, the wrist strap 22 would be stretched out flat and placed between the first and second support members 14 and 18 whereupon the support members 14 and 18 are then secured together, preferably by gluing with rubber cement. This will secure and hold the wrist strap 22 in position between the first and second support members 14 and 18.

For both hygiene (protecting the first and second support members 14 and 18 from dirt and dust) and aesthetic purposes, the first and second support members 14 and 18 are enclosed within a pliable covering 28 that has opposed slots 30 for allowing the Velcro R covered portions of the wrist strap 22 to extend outwardly therefrom. The covering 28 should be of a durable and washable material, preferably terri cloth or nylon; and for enhancing the aesthetic appeal of the portable resting pad 10, the covering 28 can be in a variety of eye-catching colors. The covering 28 is thus removable from the first and second support members 14 and 18 for cleaning and washing; and the covering's 28 placement on the first and second members 14 and 18 is facilitated by the chamfered periphery 20 of the second support member 18. In addition, the chamfered periphery 20 also reduces the likelihood of the covering 28 being torn or ripped.

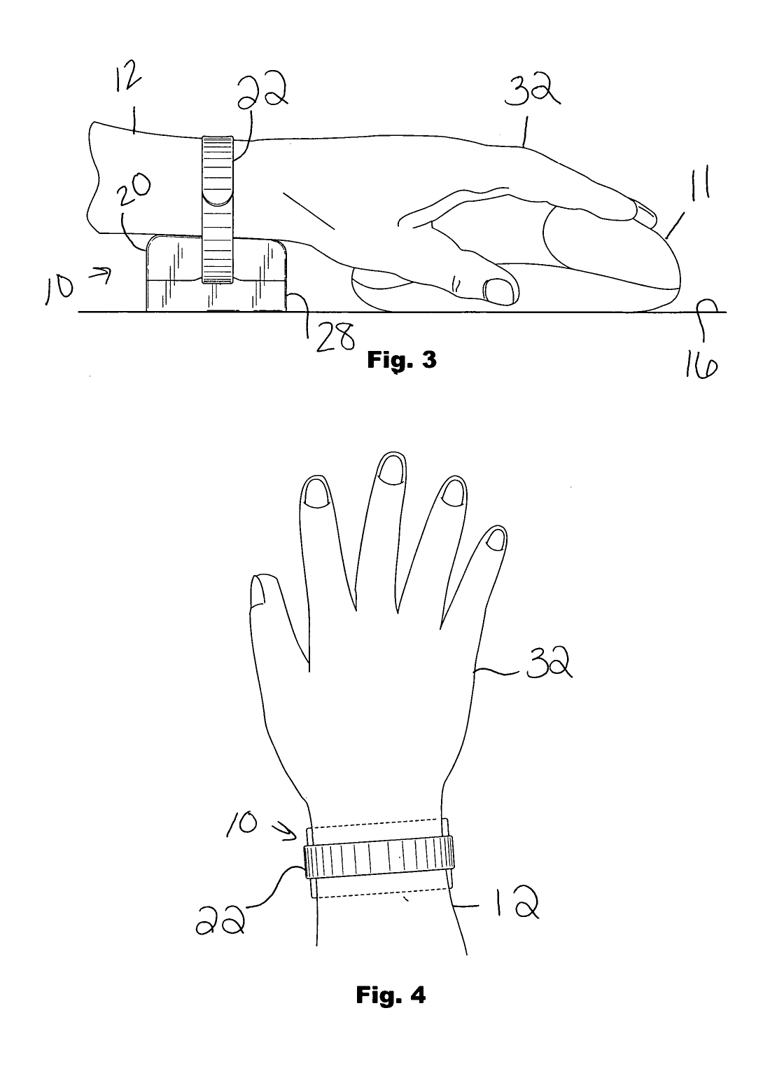

The portable resting pad 10 when assembled has the following preferred dimensions: a length of 3 inches, a width of 1½ inches and a height of ½ inch. The preferred height of the resting pad 10 elevates the wrist 12 the appropriate distance from the work surface 16 so that the wrist 12 and hand 32 are in alignment when engaged in the continuous and repetitive task of working with and manipulating, the computer mouse 11 or keyboard. This is the appropriate elevation for men, women and children. In order to use the wrist support pad 10, the pad 10 should be first placed on the work surface 16 with the wrist strap 22 fully extended as shown in FIG. 1. The underside of the user's wrist 12 is then set on the softer second support member 18 and the outwardly extending portions of the wrist strap 22 including the Velcro R hooks 24 and latches 26 are then wrapped about the user's wrist 12 and attached together as shown in FIGS. 3 and 4. Thus, with one wrist resting pad 10 attached to each wrist 12, the user can freely move his or her wrists 12, hands 32 and arms without having to physically adjust, position and reposition some type of mechanical hand and arm support mounted to the chair arm or desk after each particular movement as the wrist resting pad 10 of the present invention moves therewith easily and unobtrusively.

The foregoing discloses and describes a preferred embodiment of the invention and those skilled in the art will understand that other variations and modifications may be possible and practicable and will still come within the ambit of the appended claims.

1-8. (canceled)

9. A portable wrist rest system for attachment to a wrist of an individual for supporting and elevating the wrist above a work surface when using a computer keyboard and mouse, comprising:
a first support member for disposition on the work surface, the first support member composed of a dense foam rubber block and having a generally rectangular shape;
a second support member superposed on the first support member and upon which the wrist of the individual rests, the second support member composed of a soft foam block and having a generally rectangular shape coextensive with the generally rectangular shape of the first support member;
a wrist strap for insertion between the first and second support members and having opposed wrist portions that extend outwardly therefrom for encompassing the wrist of the individual and attaching the first and second support members to the wrist of the individual;
a pliable covering having a color for enclosing the first and second support members and having opposed slots through which the wrist portions of the wrist strap extend; and
the first support member and the second support member having a length of three inches, a width of one and one half inches, and a height of one half of an inch thereby elevating the wrist the appropriate distance above the work surface so that the wrist and the individual's hand are brought into alignment when engaged in the repetitive and continual physical activity of using the computer keyboard and computer mouse while allowing the individual to freely move the wrist and hand with the first and second support members attached to the wrist.

10. A portable wrist resting pad for attachment to a wrist of an individual for supporting and elevating the wrist above a work surface when using a computer keyboard or a computer mouse, comprising:
a first support member for disposition on the work surface, the first support member having a generally rectangular shape and composed of a dense foam rubber block;
a second support member superposed on the first support member and upon which the wrist of the individual rests, the second support member composed of a soft foam block and having a generally rectangular shape that is coextensive with the rectangular shape of the first support member;
a flexible wrist strap disposed between the first support member and the second support member for securement thereto, the flexible wrist strap having opposed wrist portions that extend outwardly from the first and second support members so that the wrist portions can encompass the wrist of the individual and attach to the wrist of the individual;
the first support member having a density that is greater than the density of the second support member;
a pliable covering having a color for enclosing the first and second support members and having opposed slots through which each wrist portion can extend; and
the first support member and the second support member having a length of three inches, a width of one and one half inches, and a height of one half of an inch thereby elevating the wrist the appropriate distance above the work surface for alleviating strain and fatigue to the carpal tunnel of the wrist, and to the wrist, hand and arm of the individual when the individual is engaged in the repetitive and continual physical activity of using the computer keyboard or the computer mouse with the individual being able to move the wrist, hand and arm with the wrist resting pad remaining attached to the wrist of the individual.
